(19) United States
(12) Patent Application Publication
(10) Pub. No.: US 2002/0023561 A1
(43) Pub. Date: Feb. 28, 2002

(54) METHOD AND A PUMPING UNIT FOR SUPPLYING PRINTING INK AND CLEANING LIQUID TO A PRINTING UNIT

(76) Inventor: HENRIK LEIMAND, BJERT (DK)

Correspondence Address: THOMAS F PETERSON, LADAS & PARRY, 224 SOUTH MICHIGAN AVENUE, CHICAGO, IL, 60604, US

(21) Appl. No.: 09/381,759

(22) PCT Filed: Mar. 24, 1998
(86) PCT No.: PCT/DK98/00115

(30) Foreign Application Priority Data
Mar. 24, 1997 (DK) 0335/97

(51) Int. Cl. B41F 31/02

(52) U.S. Cl. 101/366

(57) ABSTRACT

A pumping unit (1) for supplying printing ink to a printing unit (2) is described. In order to achieve as effective a utilization of the printing unit (2) as possible and the shortest possible time for exchanging different printing ink colors, the described pumping unit (1) is arranged with a printing ink tank (27) and a cleaning liquid tank (28). The pipe (33, 34) for sucking up or return pumping of the cleaning liquid/printing ink may be slided from a position in one or the other tank (27, 28). Process steps of inking as well as of cleaning are controlled by a central control unit (44) so that the only intervention of the operator that is necessary, is exchange of the printing ink tank (22) when a new printing ink color is to be applied in the printing unit (2).

### BACKGROUND OF THE INVENTION

The present invention relates to a method for supplying one or more printing ink colours to a printing unit and for cleaning the components of the printing unit subsequent to each colour printing.

The invention also relates to a pumping unit forming a part of a printing unit with a printing ink chamber, and which is arranged especially to be suitable for the method according to the invention.

Printing units are widely used within the graphic industry for printing multicolour prints. Thus, there will be a frequent need for quickly and simply changing different printing ink colours. This requires a quick and effective cleaning, just as there is also a requirement that as large a part of the ink as possible is returned to a printing ink tank to be used at a later printing. It is wished to return the colour to the printing ink tank to avoid contamination of cleaning water and save costs of materials.

Printing units may be used for flexographic printing, offset printing, or other kinds of printing where a colour is transferred to a printing roller or directly to a print carrier via an ink chamber.

In order to utilise the printing unit as effectively as possible, it is desired to have a printing ink color exchange unit may be performed as quickly and as automatically as possible.

From GB A 2297026 there are known a method and an apparatus for cleaning a printing unit with one or more printing ink colours. This publication describes a sequency of steps comprising an operational step where colour is circulated through the chamber, an emptying step where the chamber is emptied of printing ink which is circulated to the printing ink tank, a cleaning step where the chamber and the components of the printing unit are flushed with cleaning liquid, and a closing step where cleaning liquid is drained from the chamber. The described apparatus comprises a traditional printing ink chamber connected with a pumping unit comprising pumps for supply and return pumping of printing ink or cleaning liquid. This pumping unit is intended to support tanks for printing ink and cleaning liquid, and is arranged with pipes for sucking up and return pumping of cleaning liquid and printing ink in each of the two tanks.

With a system as described in the British publication it is possible to reduce manual handling of printing ink tanks and cleaning ink tanks and to reduce the exchange period between the different printing ink colours.

However, the system does not provide for a secure and effective cleaning of the ink chamber, but may only perform a flushing. As a result there may be remains of printing ink giving rise to problems at a subsequent operational step with a new printing ink colour.

It is a purpose of the present invention to indicate a solution which will meet the above requirements and which will also permit an effective cleaning of the printing ink chamber between changes of colour and at the same time with as little cleaning liquid consumption as possible.

This is achieved according to the present invention with a method of the kind mentioned in the introduction, as the printing unit comprises a printing ink chamber and a pumping unit with pumps for supply or return pumping of printing ink/cleaning liquid, pipes for placing in a printing ink or cleaning liquid tank for sucking up or return pumping of cleaning liquid/printing ink, and connecting conduits with shut-off and reversing valves controlled by a control unit, with the purpose of establishing the following steps:

an operational step where printing ink is circulated through the chamber,

an emptying step where the chamber is emptied of printing ink which is circulated to the printing ink tank while injecting a small amount of cleaning liquid into the chamber via nozzles and circulating the cleaning liquid together with the remaining printing ink to the printing ink tank,

a pre-flushing step where the components of the printing unit are pre-flushed with cleaning liquid from a preceding cycle pumped through the system from a cleaning liquid tank,

a cleaning step where the chamber at least once is flushed with cleaning liquid injected into the chamber via nozzles and circulated through the components of the printing unit, and

a closing step where the components of the printing unit are pumped free from/ emptied of cleaning liquid, whereafter an operational step may be commenced again.

A pumping unit according to the invention comprises pumps for supply and return pumping of printing ink/cleaning liquid from a printing ink tank and a cleaning liquid tank, respectively, pipes for placing in the tanks, and connecting conduits with shut-off and control valves controlled by a control unit, where the pumping unit is provided with a support plate on which two identical tanks may be placed side by side, where, for the purpose of supply or return pumping of cleaning liquid/printing ink, the pipes are extended through a plate acting as a lid for the printing ink tank, where the lid and the pipes are disposed vertically slidable in a bracket that may be slided along a rail in order to be positioned over one or the other tank, where, at least in the conduit between the return pump and the pipe, there is provided a valve, which may connect the conduit with a drain, and where cleaning nozzles are provided in the printing ink chamber.

According to the present invention, it will be possible to work with a cycle permitting an easy and quick change of the printing unit from one colour to another. In this way, a cycle may be started with placing a new printing ink tank on the supporting plate of the pumping unit. Then the control unit is activated. This initiates an operational step where printing ink is circulated from the printing ink tank via connecting conduits to the printing ink chamber. Before the printing ink colour is circulated, the pipes will be placed in the printing ink tank. The pipes which after finishing a preceding cleaning are in a position over the cleaning liquid tank will be slided along the rail and moved across the printing ink tank, and the pipes will automatically be lowered into the printing ink tank simultaneously with placing the lid on the tank so that splashes are avoided when the pumps are subsequently started. At this point, it will be possible to intervene manually or automatically for adjusting the speed of the pumps to accommodate for differences in viscosity, colour demands, etc.

As the printing ink chamber is provided with cleaning nozzles it is possible to establish a secure flushing of the chamber between the different operational steps with a minimum consumption of cleaning liquid. This may reduce the time for cleaning and reduce the consumption of cleaning liquid. The printing ink chamber will be partly cleaned already after the emptying step, as these cleaning nozzles are also used during the last part of the emptying step so that the remaining amount of ink together with the cleaning liquid will be circulated to the printing ink tank. Hereby the amount of cleaning liquid and the time consumed in the subsequent pre-flushing step are reduced. Finally, the amount of cleaning liquid may be further reduced, when the closing step is a reversing of the pumps for emptying the components of the printing unit of cleaning liquid so that it is kept in the cleaning liquid tank and is ready for use at the subsequent pre-flushing step.

A circulation is performed by means of the pumps in a way known by itself in the operational step. Thus, printing ink from the printing ink tank is pumped to the printing ink chamber by means of the supply pump. The excess ink in the printing ink chamber is pumped back to the ink tank by means of the return pump. Arbitrarily, during operation there may be performed a periodic flushing of sealings , etc. to keep the ink chamber clean.

When an operational step is finished, there is automatically performed an emptying and a cleaning of chamber, pumping unit, connecting conduits, etc. In this way an operator will only have to remove the printing ink tank and substitute it with a new printing ink tank. Thus, the operator does not have to perform any manual cleaning or intervention in the method.

When the chamber is emptied, this happens by reversing the supply pump so that both pumps are pumping printing ink back to the printing ink tank. At this point it will also be possible to manually or automatically open a bottom valve in the printing ink chamber, if this is necessary.

During the last part of the emptying step a flushing with a small amount of cleaning liquid is performed where the cleaning liquid is removed together with the last amount of printing ink from the ink chamber. The amount of cleaning liquid spoken of does not matter much as only small amounts are used and in the magnitude of about ½ liter.

The pumps are stopped after emptying the chamber and connecting conduits of printing ink. If there is a bottom valve, this is closed.

The bracket supporting the lid and the pumps is then automatically lifted up from the printing ink tank. The pipes will be in this position above the printing ink tank for a number of seconds until they have dripped off, so that the risk of ink drops during the subsequent transverse sliding of the bracket for placing it over the cleaning liquid tank is avoided. Right after positioning the bracket over the cleaning liquid tank, it will be possible for the operator to exchange the printing ink tank with a new containing the printing ink colour to be used in the subsequent operational sequence.

After moving the bracket over the cleaning liquid tank which is provided with its own lid, the bracket is lowered so that the pipes are submerged in the cleaning liquid tank through apertures in the lid of the tank and so that in principle there are two lids over the cleaning liquid tank. During the lowering of the pipes into the cleaning liquid tank, there will preferably be performed a flushing by means of a brushing and flushing device placed in the cleaning liquid tank, preferably in a position on the lid. Hereby, there is achieved an effective removal of colour remains at the external side of these pipes.

Once the pipes are placed in the cleaning liquid tank, the cleaning liquid contained in it from a previous cleaning will be pumped through the printing unit in the same way as printing ink, i.e. by means of the two pumps. Hereby, the components of the printing unit are pre-flushed with the cleaning liquid for a given period of time which is predetermined and programmed into the control unit. Thereafter, drain valves are swithched so that the cleaning liquid is pumped to the drain. It will be possible to open a bottom valve, if any, in the printing ink chamber.

After the printing unit has been emptied of cleaning liquid, the valves are switched again, and then there is performed a cleaning step or a number of cleaning steps in which the chamber is flushed with cleaning liquid injected into the chamber by means of high-pressure nozzles. The nozzles are preferably activated for flushing with a number of short bursts. During this flushing, the pumps are activated so that the cleaning liquid is pumped down into the cleaning liquid tank, i.e. the supply pump is reversed so that both pumps are pumping cleaning liquid to the cleaning liquid tank.

In the cleaning liquid tank, there is provided a level indicator transmitting a signal to the control unit. As a result of the signal or alternatively, because of a time control, the control unit will finish the flushing. After finishing the flushing, a rinsing is performed as the cleaning liquid is circulated through the printing unit in the same way as in an operational situation, i.e. by activating the supply and return pumps. Such a circulation is performed for a given period of time whereafter the printing unit is emptied in the same way as described above by a reversing of the supply pump so that all cleaning liquid is pumped over in the cleaning liquid tank.

If several cleaning steps are performed and the cleaning liquid will clean in the cleaning liquid tank after the last step to be utilised at a subsequent pre-flushing step.

Ending the last cleaning step, there is performed an emptying of the components of the printing unit. Hereafter, the bracket is lifted up from the cleaning liquid tank and slided along the rail to a position over a new printing ink tank which is now ready. Hereafter, the bracket may be lowered whereby the lid is placed on the printing ink tank and the pipe is submerged in the printing ink. Hereafter, an operational step may be commenced as explained above.

Activation of different valves will preferably occur pneumatically. Alternatively, activation may occur electrically or hydraulically. However, the pumping unit may be arranged very simply with pneumatic activation of the bracket by means of pneumatic cylinders which contain end stops known by themselves for indicating position over the printing ink tank or the cleaning liquid tank. The support plate on the pumping unit will preferably have a marking or an indentation which prevents a misplacing of the printing ink tank.

There are utilised ink and cleaning liquid tanks with identical openings. The lid mounted on the bracket may therefore cover the fixed lid of the cleaning liquid tank and may at the same time cover the opening on the printing ink tank, so that there is no risk of splashes of printing ink or cleaning liquid from the tanks when the pumps are running. The cleaning liquid tanks will preferably be standard buckets used for sale and storage of printing inks.

The drain connected with the pumping unit may arbitrarily lead to an external collecting tank or to another central receptacle for the contaminated cleaning liquid.

The pumping unit described here is preferably made as a separate unit with its own control system. Hereby, it may very easily be adapted to new or existing printing units as it may only be connected with these via return and supply conduits to the printing ink chamber. Alternatively, it will also be possible to make a pumping unit as an integrated part of the printing unit so that control is performed by means of a control unit which at the same time controls the printing process itself.

### DESCRIPTION OF THE DRAWING

The invention will be explained in the following in more detail with reference to the accompanying drawing, in which

FIG. 1 shows a schematic illustration of a printing unit and a pumping unit according to the present invention,

FIG. 2 shows a side view of a pumping unit according to the invention,

FIG. 3 shows an elevated view of the pumping unit shown in FIG. 2,

FIG. 4 shows a side view of the pumping unit shown in FIG. 2 according to the section on the line IV-IV, and

FIG. 5 shows a side view of the pumping unit according FIG. 2, but from the opposite side.

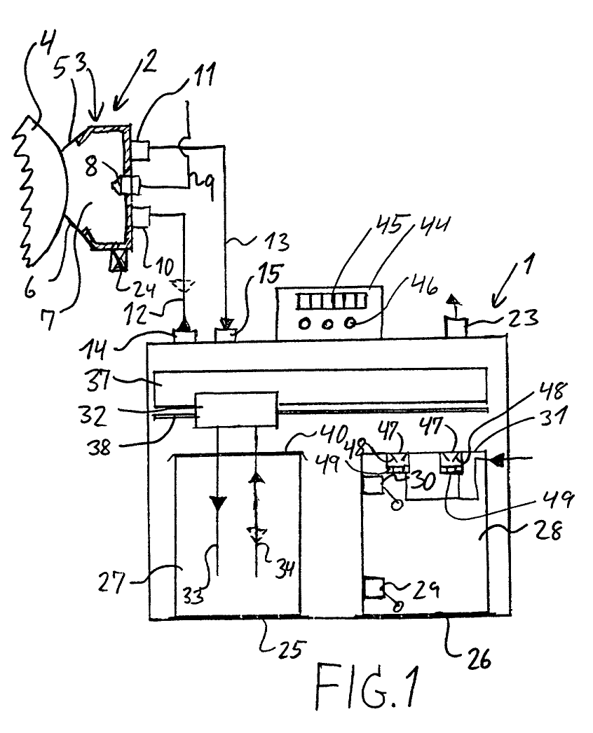

On FIG. 1 1 generally denotes a pumping unit and 2 generally denotes a printing unit. The printing unit 2 comprises a printing ink chamber 3 in the shape of a doctor chamber transferring printing ink to a roller 4. Alternatively, other kinds of printing units and ink chambers may be used. The doctor chamber 3 is provided with doctor blades 5,6 which abut against the roller 4 and which, together with the end packing (not shown), delimit a closed chamber 7 to which the printing ink is conducted. In the chamber 7 there is provided a number of cleaning nozzles 8. The nozzles 8 are connected via a conduit 9 with an external supply of cleaning liquid. The cleaning nozzles 8 may alternatively be supplied with cleaning liquid from the pumping unit 1. The doctor chamber 3 is furthermore provided with a number of inlet stubs 10 and a number of outlet stubs 11 which via connecting conduits 12,13 are in connection with the pumping unit 1, as these conduits are connected with a supply pipe 14 and a return pipe 15, respectively, for the supply and return pumping of printing ink and cleaning liquid, respectively.

The printing unit 2 is shown in a simplified form and may be of the kind which may e.g. be used for flexographic printing or offset printing.

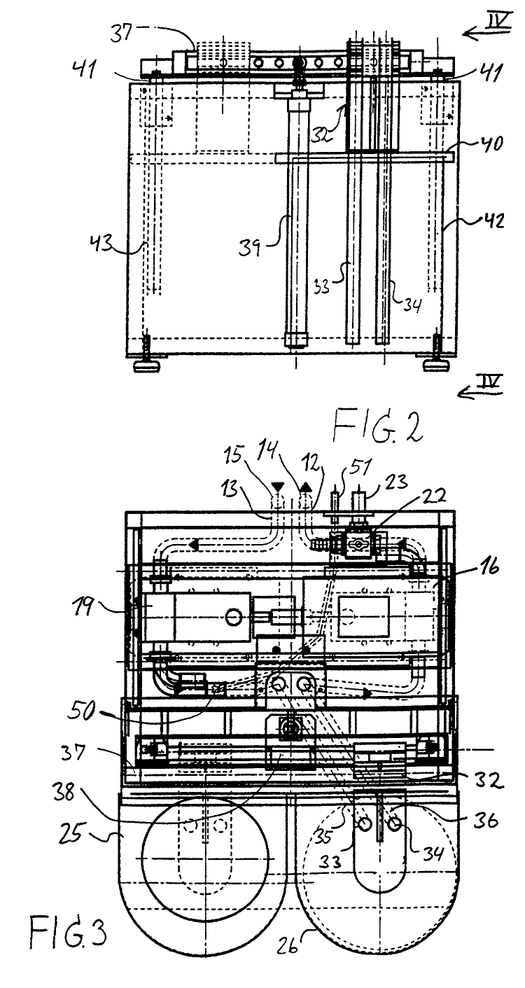

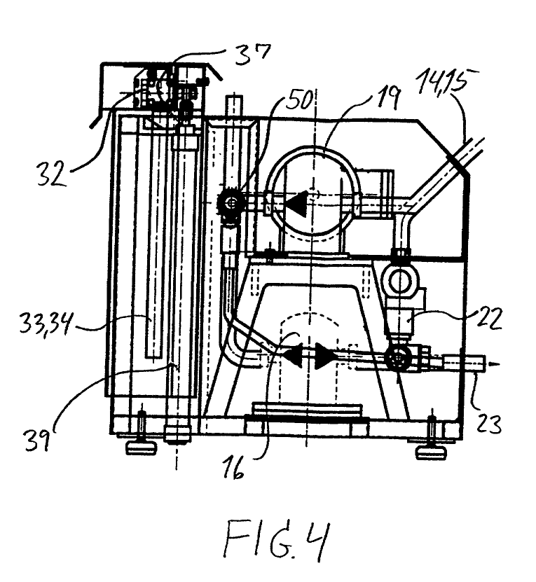

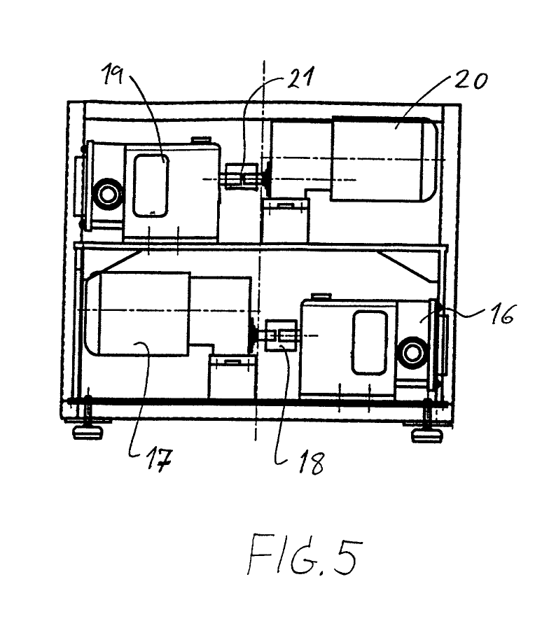

The following description of the system is given with reference to FIGS. 1-5. Certain parts are not included in all the figures for the sake of the clearness of the description. On the different Figures identical elements will be denoted with the same reference numbers. Thus, no explanation will be given to these in connection with each individual Figure.

The pumping unit 1 comprises a pump 16 which is a supply pump for printing ink and cleaning liquid to the inlet stubs 10 of the printing unit. The pump 16 is driven by a motor 17 via a coupling 18,19 denotes a pump for return pumping of printing ink and cleaning liquid from the printing unit via the outlets 11. The pump 19 is connected with a motor 20 via a coupling 21. In the connection conduit 12 for the pump 16, there is placed a reversing valve 22. The pump 16 may thus arbitrarily pump printing ink and cleaning liquid to the printing ink chamber 2 or to a drain via a stub 23.

The pump 16 is of the reversible type. It may thus be used to suck ink or cleaning liquid from the closed chamber 7. It is an advantage that the pump 16 may be used for this return pumping from the chamber, since the inlet stubs 10 are usually located in a lower position than the outlets 11. In order to achieve a complete emptying of the closed chamber 7 the chamber will also be provided with a bottom valve 24 that may be opened to drain a last amount of cleaning liquid/printing ink under the level of the inlet stub 10.

The pump unit 1 comprises two support plates 25,26 provided with indentations (not shown) for placing a tank 27 for ink and a tank 28 for cleaning liquid. In the cleaning liquid tank 28, there is mounted a lower level indicator 29 and an upper level indicator 30. The cleaning liquid tank is also provided with a lid 31.

On a bracket 32 there are mounted pipes 33,34 arranged for sucking up or return pumping of cleaning liquid/printing ink to the tanks 27,28 and which via connecting conduits 35,36 communicate with their respective pumps 19,16. In the lid 31 there are apertures 47. About these apertures there are provided brushes 48 and cleaning nozzles 49 on the lid 31 for flushing the external sides of the pines 33,34 when these are lowered in the cleaning liquid tank 28.

The pipe 33 is intended to return liquid to one of the tanks 27,28 while the pipe 34 is intended to suck up liquid from one of the tanks 27,28 and for return pumping of printing ink/cleaning liquid to the tanks. The bracket 32 is mounted slidably on a horizontal rail 37 and is activated to and from by means of a horizontal pneumatic cylinder 38. A pneumatic cylinder 39 makes it possible to lift and to lower the bracket to place the pipes 33,34 in a tank or to remove these from a tank when they are to be transferred from one tank to another.

The pipes 33, 34 pass through a plate 40 fastened to the pipes and which acts as a lid for the tank 27 when the pipes are placed in the tank. The tank 27 is a standard bucket used for storage and transportation of printing ink. The cleaning ink tank 28 is a tank that may have the same dimensions as a standard bucket. The cleaning liquid tank has its own lid 31 as mentioned above and comprises furthermore the level indicators 29,30. The cleaning liquid tank may be provided with a separate bottom drain (not shown).

The pneumatic cylinder 39 lifts the bracket as it lifts the whole rail 37. The lifting and lowering of the rail 37 is controlled by means of vertical bars 41 connected with the rail and guided into vertical guide means 42,43.

The different components forming a part of the pumping unit 1 are connected with a control unit 44 with a display 45 and adjusting buttons 46, which for example may be used for starting and stopping an operational cycle with inking, start and stop of the cleaning cycle, where cleaning liquid is used for controlling the speed of the pumps, etc. The control unit 44 is arranged so that automatic switching of the valves and control of cylinders, etc. for an automatic operation of the pumping unit are performed.

Furthermore, the pumping unit 1 contains a further drain valve 50 placed in the connecting conduit between the pump 19 and the pipe 33 and which permits a complete emptying to the drain via a further drain stub 51.

1. A method for supplying one or more printing ink colours to a printing unit (2) and for cleaning the components of the printing unit after each colour printing, which printing unit comprises a printing ink chamber (7) and a pumping unit (1) with pumps (16,19) for supply or return pumping of printing ink/cleaning liquid, pipes (33,34) for placing in a printing ink/cleaning liquid tank (27,28) for sucking up or return pumping of cleaning liquid/printing ink, and connecting conduits (12,13) with shut-off and reversing valves controlled by a control unit (44), with the purpose of establishing the following steps:
an operational step where printing ink is circulated through the chamber (7),
an emptying step where the chamber (7) is emptied of printing ink which is circulated to the printing ink tank (27) while injecting a small amount of cleaning liquid into the chamber via nozzles (8) and circulating the cleaning liquid together with the remaining printing ink to the printing ink tank,
a pre-flushing step where the components of the printing unit are pre-flushed with cleaning liquid from a preceding cycle pumped through the system from a cleaning liquid tank,
a cleaning step where the chamber (7) at least once is flushed with cleaning liquid injected into the chamber via nozzles and circulated through the components of the printing unit, and
a closing step where the components of the printing unit are pumped free from/emptied of cleaning liquid, whereafter an operational step may be commenced again.

2. A method according to claim 1, characterised in that the operational step comprises
that a printing ink tank (27) is provided in the pumping unit (1),
that the pipes are placed above and lowered into the printing ink tank (27),
that printing ink is circulated through the ink chamber (7) while excess ink is pumped back to the printing ink tank;
that the emptying step comprises
that the pumps (16,19) are reversed so that printing ink is pumped back to the printing ink tank,
that the pipes (33,34) are lifted up from the printing ink tank subsequent to circulating of the remaining printing ink and the cleaning liquid to the printing ink tank;
that the pre-flushing step comprises
that the pipes are placed in the cleaning liquid tank (28) and that the pumps (16,19) are activated for circulating the cleaning liquid through the components of the printing unit,
that the pipes are flushed while placed in the cleaning liquid tank,
that subsequently to the pre-flushing, the cleaning liquid is pumped to a drain so that the components of the printing unit and the cleaning liquid tank are emptied;
that the cleaning step comprises
that the chamber (7) is flushed with high pressure nozzles (8) simultaneously with pumping the cleaning liquid into the cleaning liquid tank (28),
that the flushing is stopped as a result of a signal indicating that the cleaning liquid tank is full,
that the pumps (16,19) are continuously activated for circulating the cleaning liquid, and
that the cleaning liquid is pumped to the drain;
that the closing step comprises
that the pipes are removed from the cleaning liquid tank, and
that the pumps are reversed so that the components of the printing unit are emptied of the cleaning liquid, as the cleaning liquid from the last flushing is kept in the cleaning liquid tank.

3. A method according to claim 1 or 2, characterised in that the steps comprising pumping of cleaning liquid to the drain, there is performed an automatic switching of a drain valve (50) while the the pumps are activated.

4. A method according to any of the preceding claims, characterised in that the pipes when moved into and out of the tanks are moved substantially rectilinearly, and that they, by their transfer from one tank to another, are moved substantially horizontally as two juxtaposed tanks are used as printing ink tank and cleaning liquid tank, respectively.

5. A pumping unit (1) forming a part of a printing unit (2) with a printing ink chamber (7) and comprising pumps (16,19) for supply and return pumping of printing ink/cleaning liquid from a printing ink tank (27) and a cleaning liquid tank (28), respectively, pipes (33,34) for placing in the tanks (27,28), and connecting conduits (12,13) with shut-off and control valves controlled by a control unit (44), where the pumping unit (1) is provided with a support plate (25,26) on which two identical tanks (27,28) may be placed side by side, where for the purpose of supply or return pumping of cleaning liquid/printing ink the pipes (33,34) are extended through a plate acting as a lid for the printing ink tank, where the lid and the pipes are disposed vertically slidable in a bracket (32) that may be slided along a rail (37) in order to be positioned over one or the other tank, where, at least in the conduit (12) between the return pump (16) and the pipe (34), there is provided a valve (22), which may connect the conduit with a drain, and where cleaning nozzles are provided in the printing ink chamber.

6. A pumping unit according to claim 5, characterised in that the bracket (32) is mounted on pneumatic cylinders (39) providing the upwards and downwards movement in the tank and the traversing movement between positions over the two tanks (27,28).

7. A pumping unit according to claim 5 or 6, characterised in that it is made as a separate unit connected with the remaining part of the printing unit via the supply and return conduits (12,13) to the printing ink chamber.

8. A pumping unit according to any of the claims 5-7, characterised in that at least the supply pump (16) is reversible.

9. A pumping unit according to any of the claims 5-8, characterised in that the cleaning liquid tank (28) is provided with level indicators (29,30) arranged for transmitting signals to the control unit (44) with the purpose of controlling start and stop moments for the cleaning process.

10. A pumping unit according to any of the claims 5-9, characterised in that the printing ink tanks (27) are constituted by standard buckets used for sale and storage of printing ink for the printing unit (1).
